(19) United States
(12) Patent Application Publication
(10) Pub. No.: US 2026/0336922 A1
(43) Pub. Date: Oct. 29, 2026

(54) WASTE RECEPTACLE

(71) Applicant: NINGBO SINCERE LEISURE PRODUCTS CO., LTD., Ningbo (CN)

(72) Inventor: Wenguang Lu, Ningbo (CN)

(21) Appl. No.: 19/638,078

(22) Filed: Apr. 2, 2026

(30) Foreign Application Priority Data
Apr. 23, 2025 (CN) 2025105122855
Jan. 30, 2026 (CN) 2026101336972

(51) Int. Cl. B65F 1/06; B65F 1/16

(52) U.S. Cl. CPC B65F 1/068; B65F 1/163; B65F 2210/126; B65F 2210/167; B65F 2230/108

(57) ABSTRACT

This application provides a waste receptacle, comprising a housing assembly comprising a main housing body, a housing cover, a waste cartridge, a closing assembly, and an accommodating housing; wherein the closing assembly comprises a closing member and a switching member, the switching member being connected to the closing member for controlling the opening or closing of the closing member, wherein when the closing member is in an open state, refuse passing through the waste cartridge drops into a garbage bag, and when the closing member is in a closed state, it serves to clamp the garbage bag tightly. The entire process can be performed without opening the housing cover, which effectively reduces to odor leakage from the garbage bag and achieves odor isolation.

### CROSS-REFERENCE TO RELATED APPLICATIONS

This application claims priority to Chinese Patent Application No. 202610133697.2, filed on Jan. 30, 2026, and 202510512285.5, filed on Apr. 23, 2026, the content of which is incorporated herein by reference in their entireties.

### TECHNICAL FIELD

The present application relates to the technical field of environmental protection equipment, and specifically relates to a waste receptacle.

### BACKGROUND

A trash can, also known as a waste bin or garbage bin, refers to a container for holding refuse. Most are made of metal or plastic, with a plastic bag placed inside for use; when the garbage accumulates, the bag can be tied up and disposed of.

However, existing waste receptacles have relatively simple functions and are only capable of storing refuse. For example, they do not have functions for treating odors in the waste receptacle, or even if they possess some simple treatment functions, the effects are poor.

### SUMMARY

The objective of the present application is to provide a waste receptacle capable of achieving more effective odor isolation.

Embodiments of the present application provide a waste receptacle, comprising:
a housing assembly comprising a main housing body, a housing cover, and a waste container, wherein the main housing body is configured with a channel along a first direction, one end of the channel being configured as an inlet and the other end being configured as an outlet, the housing cover being connected to one side of the main housing body for opening or closing the inlet, and the waste container being disposed in the channel for providing a garbage bag;
a closing assembly comprising a closing member and a switching member, the closing member being disposed at the outlet, the switching member being connected to the closing member for controlling opening or closing of the closing member, wherein when the closing member is in an open state, refuse passing through the waste container drops into the garbage bag, and when the closing member is in a closed state, the closing member is adapted to clamp the garbage bag.

In the above implementation, the channel of the main housing body is provided with the waste container, the housing cover is located at a side of the inlet of the main housing body, and the closing assembly is located at a side of the outlet of the main housing body. When refuse disposal is required, the housing cover is first opened, and after passing through the waste container, the refuse drops to the closing member. At this time, the closing member may be in a closed state. Subsequently, the inlet is closed by the housing cover, and the closing member is opened by the switching member. After the refuse drops into the garbage bag, the closing member clamps the garbage bag. The entire process can be performed without keeping the housing cover open, effectively reducing odor leakage from the garbage bag and achieving odor isolation.

In some embodiments, the closing member includes a first closing door and a second closing door, and the switching member includes a first switch and a second switch, the first switch being connected to the first closing door and the second switch being connected to the second closing door, wherein when the first switch and the second switch approach each other, the first closing door and the second closing door move away from each other, and when the first switch and the second switch move away from each other, the first closing door and the second closing door approach each other.

In the above implementation, the first closing door is controlled by the first switch, and the second closing door is controlled by the second switch. When it is necessary to place refuse into the garbage bag, it is only required to control the first switch and the second switch to approach each other. After the refuse enters the garbage bag, the first closing door and the second closing door can automatically return to their original positions to clamp the garbage bag, effectively reducing odor leakage from the garbage bag and achieving odor isolation.

In some embodiments, the first closing door is configured with a first engaging portion, and the second closing door is configured with a second engaging portion, the first engaging portion being configured to engage with the second engaging portion.

In the above implementation, the engagement between the first closing door and the second closing door ensures synchronous rotation of the first closing door and the second closing door when the user operates the first switch and the second switch, while effectively improving structural stability and the clamping force of the closing assembly on the garbage bag when closed.

In some embodiments, one end of the closing member abuts against the main housing body, and the other end extends in a direction away from the main housing body and converges toward a central axis of the closing member. This configuration not only facilitates clamping of the garbage bag but also facilitates dropping of refuse into the garbage bag after the user disposes the refuse, reducing contamination of the closing member by refuse and minimizing odor leakage.

In some embodiments, the closing member is rotatably connected to the main housing body. This facilitates control of the closing member by the user through the switching member, and after the user releases the switching member, the closing member can automatically close to achieve sealing of the garbage bag.

In some embodiments, the waste receptacle further comprises a cutting assembly connected to a side of the main housing body proximal to the switching member for cutting the garbage bag.

In the above implementation, the cutting assembly and the switching member are located on the same side of the main housing body, which can be used to cut the garbage bag without excessively pulling the garbage bag, thereby preventing the waste receptacle from tipping or overturning during cutting of the garbage bag, while making operation more convenient and user-friendly.

In some embodiments, the housing cover includes a first cover body and a second cover body, the first cover body being sleeved on the main housing body, and the second cover body being located at a side of the first cover body distal from the main housing body.

In the above implementation, the first cover body is connected to the main housing body and can guide refuse into an inner cavity of the waste container when the user disposes refuse, while the second cover body is connected to the main housing body and can be used to cover a side of the housing assembly proximal to the inlet, facilitating multiple sealing of the garbage bag and reducing gas leakage during refuse disposal.

In some embodiments, the housing assembly further comprises an accommodating housing connected to a side of the main housing body proximal to the outlet, and the accommodating housing is configured with a storage space adapted to accommodate a portion of the garbage bag passing through the closing member.

In some embodiments, the housing assembly further comprises a cover door connected to the accommodating housing for removing the garbage bag.

In some embodiments, the housing assembly further comprises a supporting base connected to a side of the accommodating housing distal from the main housing body.

Other features and advantages of the present application will be set forth in the description which follows, or may be learned by practice of the present application, or may be learned from the description or determined therefrom without doubt, or may be learned by implementation of the above technical solution of the present application.

To make the above-mentioned objectives, features, and advantages of the present application more comprehensible, preferred embodiments are hereinafter described in detail with reference to the accompanying drawings.

### BRIEF DESCRIPTION OF THE DRAWINGS

In order to more clearly illustrate the technical solutions of the embodiments of the present application, a brief introduction is hereinafter made to the accompanying drawings required for use in the embodiments of the present application. It should be understood that the following drawings merely show certain embodiments of the present application and therefore should not be considered as limitations to the scope. For those of ordinary skill in the art, other related drawings may also be obtained from these drawings without creative efforts.

FIG. 1 is a structural schematic diagram of a waste receptacle provided by an embodiment of the present application;

FIG. 2 is an exploded schematic diagram of the waste receptacle provided by an embodiment of the present application;

FIG. 3 is a partial structural schematic diagram of the waste receptacle provided by an embodiment of the present application;

FIG. 4 is a schematic diagram of an internal structure of an accommodating housing of the waste receptacle provided by an embodiment of the present application;

FIG. 5 is a front view structural schematic diagram of a closing assembly of the waste receptacle provided by an embodiment of the present application;

FIG. 6 is a rear view structural schematic diagram of the closing assembly of the waste receptacle provided by an embodiment of the present application;

FIG. 7 is a structural schematic diagram of a first closing door of the waste receptacle provided by an embodiment of the present application;

FIG. 8 is a structural schematic diagram of a second closing door of the waste receptacle provided by an embodiment of the present application;

FIG. 9 is a structural schematic diagram of a switching member of the waste receptacle provided by an embodiment of the present application.

### DETAILED DESCRIPTION OF THE EMBODIMENTS

This application is described below in conjunction with the accompanying drawings in the embodiments of the present application with respect to the technical solutions in the embodiments of the present application, which are clear and complete descriptions. Apparently, the described embodiments are merely a part of the embodiments of the present application, rather than all of the embodiments.

In existing products in the prior art, a common lid is usually provided to cover the opening at the upper part of the waste receptacle; however, the sealing effect is generally poor, which tends to cause odor leakage and results in poor user experience. Although a sealed lid has been developed thereafter, while this type of sealed lid can prevent odor leakage when closed, odor will still leak out when the user opens the lid to dispose of refuse, which is very unfavorable in enclosed spaces. For example, in winter and summer seasons, when users use air conditioning at home in enclosed scenarios, if odor leaks out when opening the waste receptacle lid, it will be difficult to dissipate in a timely manner.

In view of this defect, the present application not only achieves a first sealing through the housing cover 102, but also adds the closing assembly 20 to achieve a second sealing, which can achieve more effective odor isolation and solve the above-mentioned problem of malodorous gas leakage when the user opens the lid and disposes of refuse again.

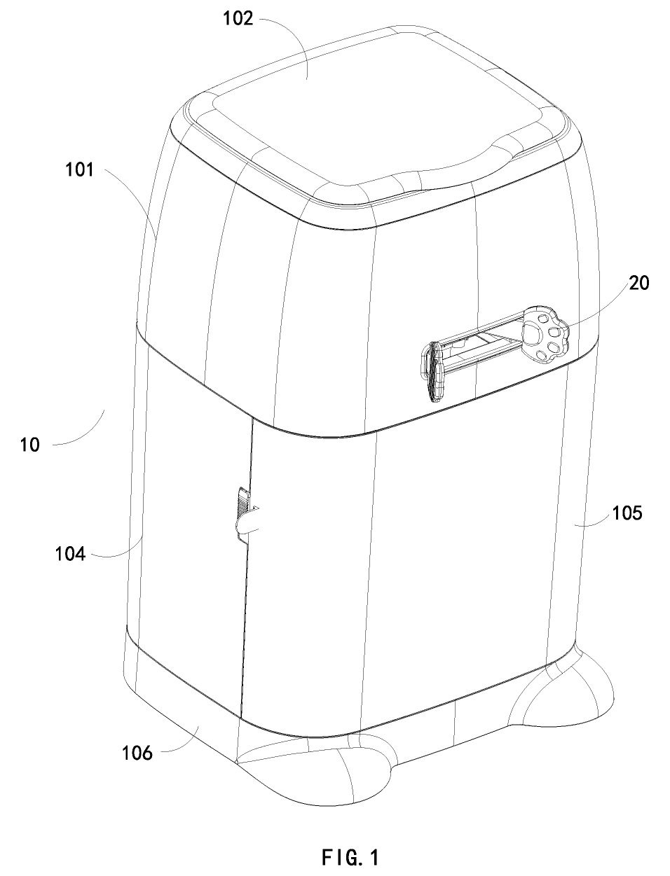

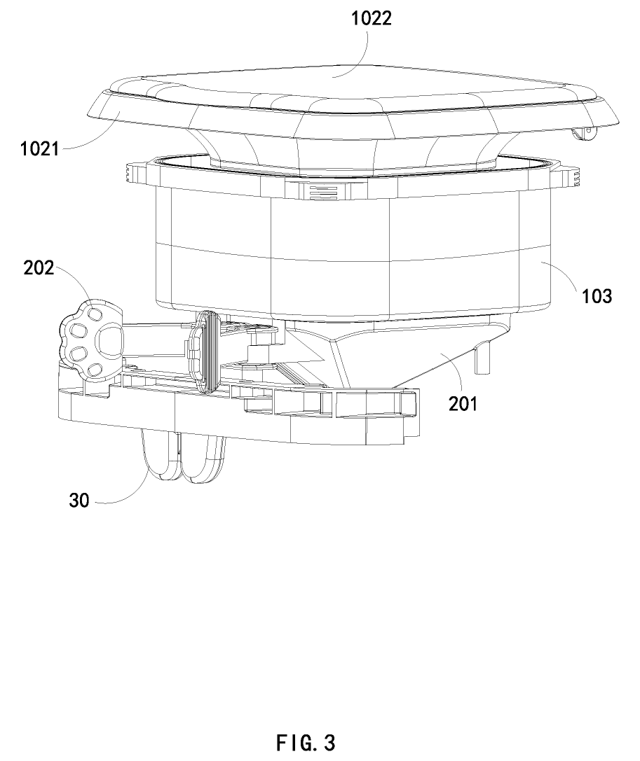

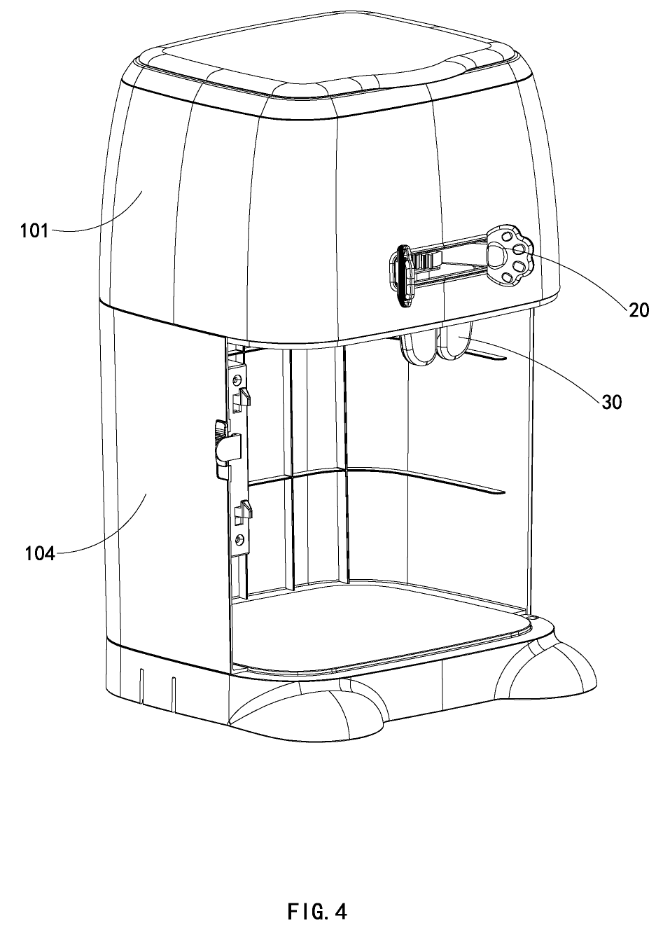

As shown in FIGS. 1-5, in a first aspect, an embodiment of the present application provides a waste receptacle, comprising: a housing assembly 10 and a closing assembly 20, the closing assembly 20 being connected to the housing assembly 10, a garbage bag in the housing assembly 10 passing through the closing assembly 20 and extending to a lower side of the closing assembly 20, so that when the closing assembly 20 is in a closed state, the garbage bag can be clamped. After the user disposes of refuse at a side of the housing assembly 10 opposite to the downward extending direction of the closing assembly 20, the opening at the upper end of the housing assembly 10 is closed, and then the user operates the closing assembly 20 to open it, so that the refuse drops into the garbage bag under its own gravity to complete the refuse disposal. Subsequently, when the user releases the closing assembly 20, the closing assembly 20 returns to a closed state. It can be understood that after the inlet of the housing assembly 10 is opened for refuse disposal, and after the refuse is disposed and the inlet of the housing assembly 10 is closed, and before the closing assembly 20 is operated, the closing assembly 20 can always be maintained in a closed state. That is to say, the entire operation process takes a very short time, and the entire refuse disposal action does not need to be performed with the closing assembly 20 in an open state, so that malodorous and fermented odors stored in the garbage bag below are not easily leaked. Thus, the user can perceive minimal odor emanating from the garbage bag, greatly enhancing the user experience.

Specifically, the housing assembly 10 includes a main housing body 101, a housing cover 102, and a waste container 103. The main housing body 101 is configured with a channel along a first direction, one end of the channel being configured as an inlet and the other end being configured as an outlet. The housing cover 102 is connected to one side of the main housing body 101 for opening or closing the inlet. The waste container 103 is disposed in the channel for providing a garbage bag (storing garbage bags in a stacked manner). The closing assembly 20 includes a closing member 201 and a switching member 202. The closing member 201 is disposed at the outlet. The switching member 202 is connected to the closing member 201 for controlling opening or closing of the closing member 201. When the closing member 201 is in an open state, refuse passing through the waste container 103 drops into the garbage bag. When the closing member 201 is in a closed state, the closing member 201 is adapted to clamp the garbage bag, and the refuse is retained/supported above the closing member 201 and cannot drop. A rectangular window is also opened on the front side of the main housing body 101, and one end of the switching member 202 extends out of the main housing body 101 through the rectangular window to facilitate manual operation.

Exemplarily, the first direction includes but is not limited to an up-down direction. The main housing body 101 has an inlet configured at its upper end and an outlet configured at its lower end. The housing cover 102 is connected to the upper end of the main housing body 101, and the connection manner may be a rotatable connection. Meanwhile, when the housing cover 102 closes the inlet of the main housing body 101, the periphery of the housing cover 102 is in sealed contact with the main housing body 101 to ensure that no odor will leak out after the housing cover 102 covers the inlet, improving the user experience.

It can be understood that regarding the specific structure of the waste container 103, it may be a specially designed structure or a structure of existing products. Meanwhile, to meet users' demands for garbage bags of different sizes, the waste container 103 can be replaced with different sizes or suitable models for users to freely choose. For example, the waste container 103 is of a hollow structure along the first direction, and a plurality of independent garbage bags are arranged therein, with adjacent garbage bags connected sequentially. Alternatively, it may be a continuous hollow garbage bag, and each time the garbage bag is pulled down, the user can manually tie a knot at the lower end of the garbage bag, or a sealing device is arranged at the lower end of the main housing body 101, so that when the user disposes of refuse, the refuse can pass through the waste container 103 and enter the garbage bag for collection.

The closing assembly 20 is located at the outlet, preferably arranged at a position close to the outlet below the waste container. The closing member 201 is connected to the main housing body 101. After the user takes out the garbage bag full of refuse and needs to pull down the garbage bag in the waste container 103 again, the closing member 201 is opened through the switching member 202 to allow the garbage bag to pass through the closing member 201. Finally, the switching member 202 is released, and the closing member 201 clamps the garbage bag to effectively reduce odor leakage from the garbage bag.

In the above implementation, the channel of the main housing body 101 is provided with the waste container 103, the housing cover 102 is located at a side of the inlet of the main housing body 101, and the closing assembly 20 is located at a side of the outlet of the main housing body 101. When refuse disposal is required, the housing cover 102 is first opened, and after passing through the waste container 103, the refuse drops to the closing member 201. At this time, the closing member 201 is in a closed state. Subsequently, the inlet is closed by the housing cover 102, and the closing member 201 is opened by the switching member 202. After the refuse drops into the garbage bag, the closing member 201 clamps the garbage bag. That is, the entire process of the refuse disposed by the user dropping from the closing member 201 to the garbage bag below can be performed without keeping the housing cover 102 open. The fermented odor isolated and stored in the garbage bag below is effectively isolated, effectively reducing odor leakage from the garbage bag and achieving odor isolation.

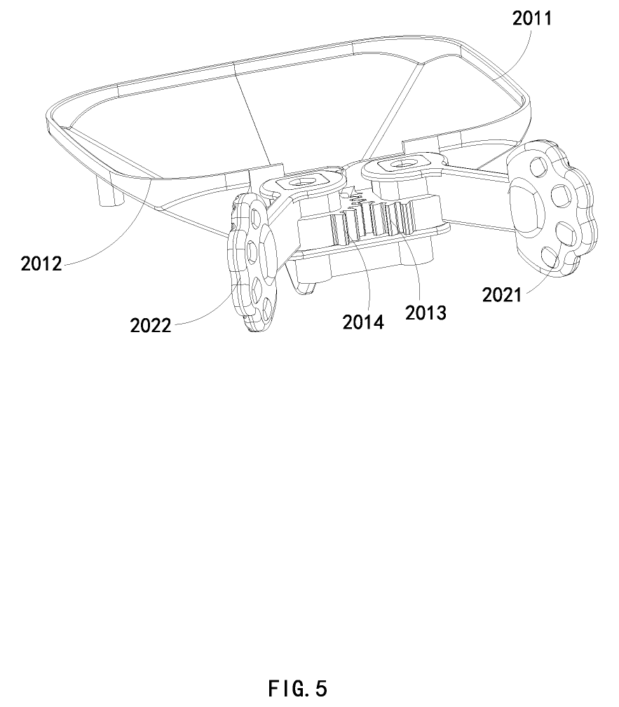

As shown in FIG. 5, the closing member 201 includes a first closing door 2011 and a second closing door 2012. The switching member 202 includes a first switch 2021 and a second switch 2022. The first switch 2021 is connected to the first closing door 2011, and the second switch 2022 is connected to the second closing door 2012. When the first switch 2021 and the second switch 2022 approach each other, the first closing door 2011 and the second closing door 2012 move away from each other. When the first switch 2021 and the second switch 2022 move away from each other, the first closing door 2011 and the second closing door 2012 approach each other.

Exemplarily, when the closing member 201 is in a closed state, the first closing door 2011 and the second closing door 2012 are in a state of mutual contact. Meanwhile, to ensure uniformity of force applied by the user to the switching member 202 during the process of controlling the closing member 201 to open and improve the experience, a side of the first switch 2021 distal from the first closing door 2011 and a side of the second switch 2022 distal from the second closing door 2012 both extend to an outer side of the main housing body 101. The first closing door 2011 and the second closing door 2012 are configured as symmetrical structures. The first switch 2021 includes but is not limited to a door handle, and the second switch 2022 includes but is not limited to a door handle. The first switch 2021 is in limited connection with the first closing door 2011, and the second switch 2022 is in limited connection with the second closing door 2012. The first switch 2021 and the second switch 2022 are distributed in an inverted V-shape to drive the movement of the first closing door 2011 and the second closing door 2012 through the first switch 2021 and the second switch 2022.

It can be understood that to achieve automatic closing of the closing member 201 after it is opened, a first spring is arranged between the first closing door 2011 and the first switch 2021, and a second spring is arranged between the second closing door 2012 and the second switch 2022. When the first closing door 2011 and the second closing door 2012 move away from each other to render the closing member 201 in an open state, the first spring and the second spring gradually form the potential energy required when the closing member 201 is closed. Thus, after the user releases the first switch 2021 and the second switch 2022, the first closing door 2011 and the second closing door 2012 automatically close to clamp the garbage bag. Meanwhile, under the combined action of the first spring and the second spring, the clamping force of the closing member 201 on the garbage bag can be ensured to reduce odor leakage from the garbage bag. The arrangement of the elastic elements is not limited to the above scheme, and elements with similar functions in existing designs may also be used to achieve the automatic closing effect of the closing member.

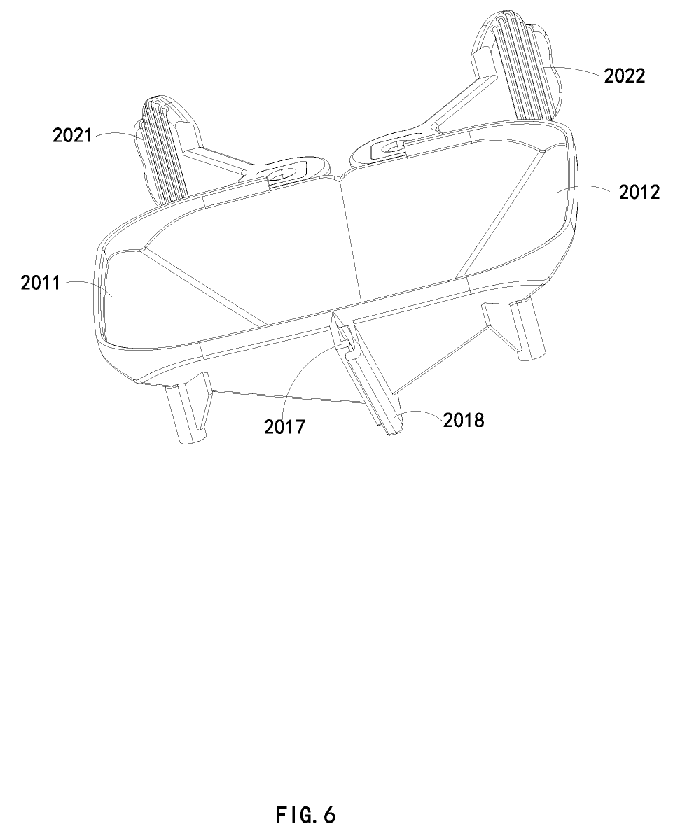

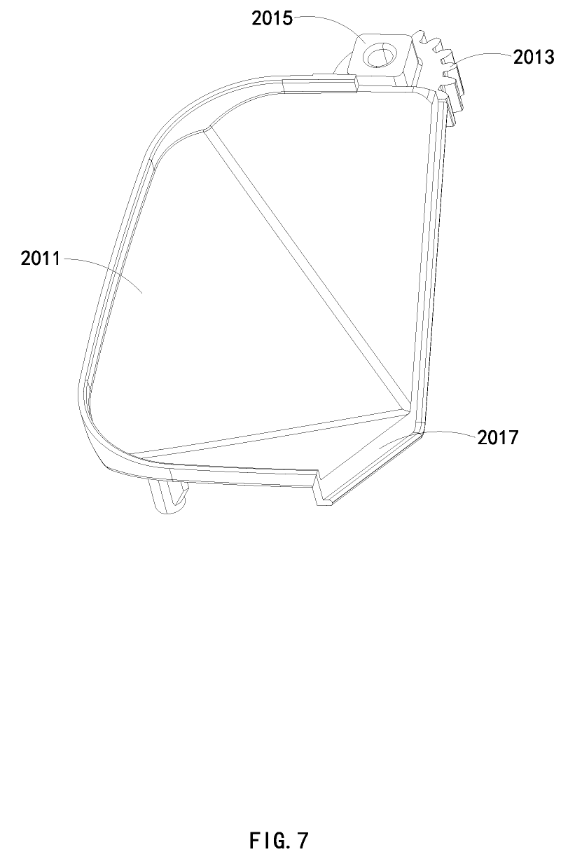

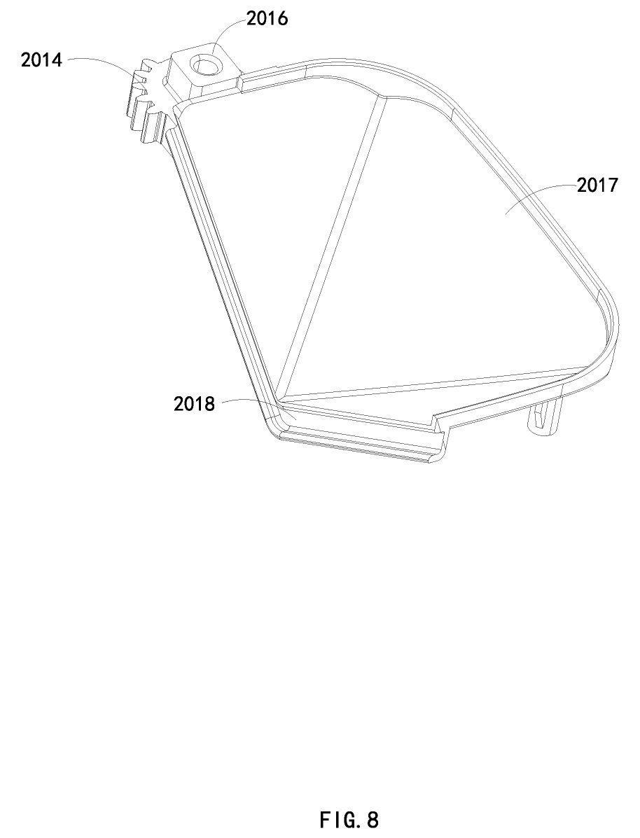

Referring to FIGS. 6-9, to achieve synchronous rotation of the switching member 202 and the closing member 201, the connection manner may adopt the following: the first switch 2021 is configured with a first polygonal hole 2061, and the first closing door 2011 is configured with a first extending body 2015. The first extending body 2015 is configured as a polygonal outer peripheral protrusion adapted to the first polygonal hole 2061. The second switch 2022 is configured with a second polygonal hole 2062, and the second closing door 2012 is configured with a second extending body 2016. The second extending body 2016 is configured as a polygonal outer peripheral protrusion adapted to the second polygonal hole 2062. After adaptation, when the user presses and rotates the switching member 202 manually, torque is transmitted to the closing member 201 through the combination of the polygonal holes and the extending bodies to drive the closing member 201 to rotate. Of course, in other embodiments, the first switch 2021 and the first closing door 2011 may be integrally formed or fixed by screws, and the second switch 2022 and the second closing door 2012 may be integrally formed or fixed by screws.

In the above implementation, the first closing door 2011 is controlled by the first switch 2021, and the second closing door 2012 is controlled by the second switch 2022. When it is necessary to place refuse into the garbage bag, it is only required to control the first switch 2021 and the second switch 2022 to approach each other. After the refuse enters the garbage bag, the first closing door 2011 and the second closing door 2012 can automatically return to their original positions to clamp the garbage bag, effectively reducing odor leakage from the garbage bag and achieving odor isolation.

Please refer to FIG. 5 again. The first closing door 2011 is configured with a first engaging portion 2013, and the second closing door 2012 is configured with a second engaging portion 2014. The first engaging portion 2013 is configured to engage with the second engaging portion 2014.

Exemplarily, partial structures of the first closing door 2011 and the second closing door 2012 are in contact, and at this contact position, the first closing door 2011 is configured with the first engaging portion 2013, and the second closing door 2012 is configured with the second engaging portion 2014. Both the first engaging portion 2013 and the second engaging portion 2014 are of a toothed configuration. The first engaging portion 2013 and the second engaging portion 2014 are correspondingly provided with the first extending body 2015 and the second extending body 2016 at upper sidesthereof. After an external force is applied to the first switch 2021 and the second switch 2022, the closing member 201 can rotate along the distribution direction of the first engaging portion 2013 and the second engaging portion 2014, ultimately achieving opening and closing of the closing member 201.

More specifically, a first arc body is configured at one side of the first closing door 2011, and a second arc body is arranged at one side of the second closing door 2012. The first engaging portion 2013 is configured on an outer periphery of the first arc body, and the second engaging portion 2014 is configured on an outer periphery of the second arc body. The length dimensions of the first engaging portion 2013 and the second engaging portion 2014 are not specifically limited.

In the above implementation, the engagement between the first closing door 2011 and the second closing door 2012 ensures synchronous rotation of the first closing door 2011 and the second closing door 2012 after the user operates the first switch 2021 and the second switch 2022, while effectively improving structural stability and the clamping force of the closing assembly 20 on the garbage bag when closed.

In one of the embodiments, one end of the closing member 201 abuts against the main housing body 101, and the other end extends in a direction away from the main housing body 101 and converges toward a central axis of the closing member 201. For example, the closing member 201 is configured in a tapered shape, and the upper end of the closing member 201 has a larger dimension than its lower end. This configuration not only facilitates clamping of the garbage bag but also facilitates dropping of refuse into the garbage bag after the user disposes of the refuse, reducing contamination of the closing member 201 by refuse and minimizing odor leakage.

Referring to FIGS. 6-8, to improve the sealing effect and maintain the sealing effect for a longer time, the present application specially sets the abutting portions of the first closing door 2011 and the second closing door 2012. As mentioned above, the closing member 201 as a whole is of a tapered shape, and its cross-section is V-shaped. The sealing at the abutting edges of the first closing door 2011 and the second closing door 2012 is crucial to the overall anti-leakage effect. If fine refuse residue occurs during use or the elastic clamping force decreases after long-term use, odor leakage will occur at the abutting edges.

The present application arranges an L-shaped first downward extending edge 2017 at the abutting edge of the first closing door 2011, and an approximately U-shaped second downward extending edge 2018 at the abutting edge of the second closing door 2012. The bottom position of the first downward extending edge 2017 is higher than the bottom position of the second downward extending edge 2018. When no pressure is applied to the switching member 202 by hand (the switching member is in a released state), the closing door is in a tightened state. At this time, the first downward extending edge 2017 abuts against the second downward extending edge 2018, and during the abutting process of the two, since the bottom position of the first downward extending edge 2017 is higher than the bottom position of the second downward extending edge 2018, the bottom side of the first downward extending edge 2017 extends into the U-shaped groove of the second downward extending edge 2018.

To further explain the benefits of the design of the present application, after refuse is disposed, the refuse will stay above the closing member 201. After the user presses the switching member 202, large pieces of refuse drop to the garbage bag below under gravity, while some fine refuse, especially some moist refuse, such as a mixture of cat litter and cat excrement, will have cat litter particles adhering to the garbage bag and cannot completely fall off. At this time, the abutting portion of the closing door is easily blocked by these cat litter particles and cannot achieve complete closure. In addition, when the closing member 201 is tightened, the garbage bag clamped therein is not of a regular shape, and there will often be situations where one part has more wrinkles and another part has fewer wrinkles. If a smooth closing door abutting portion is used, leakage is prone to occur at the wrinkled part of the closing door abutting portion.

Referring to FIG. 6, through the mutual embedded abutting of the first downward extending edge 2017 and the second downward extending edge 2018, the L-shaped lower end of the first downward extending edge 2017 can extend a certain dimension into the U-shaped groove of the second downward extending edge 2018. Based on the gravity action of the garbage bag below (especially when there is a certain amount of refuse), the garbage bag itself forms a certain tension at the abutting portion of the closing member. At this time, through the extension of the L-shaped lower end of the first downward extending edge 2017 a certain dimension into the U-shaped groove of the second downward extending edge 2018, the gathered opening of the garbage bag can be clamped to the maximum extent. Even if there are some fine particles or wrinkles, they can be clamped to the maximum extent to prevent odor leakage.

The design of the present application can also prevent insufficient clamping force caused by aging to a greater extent. Springs or plastic equipment itself will experience fatigue with increased use time. After a period of use, it is common to experience situations where clamping is not tight. By arranging the L-shaped lower end of the first downward extending edge 2017 to extend a certain dimension into the U-shaped groove of the second downward extending edge 2018, where this extending dimension can be appropriately enlarged to enhance resistance to equipment aging fatigue, a lasting anti-leakage effect can be maintained.

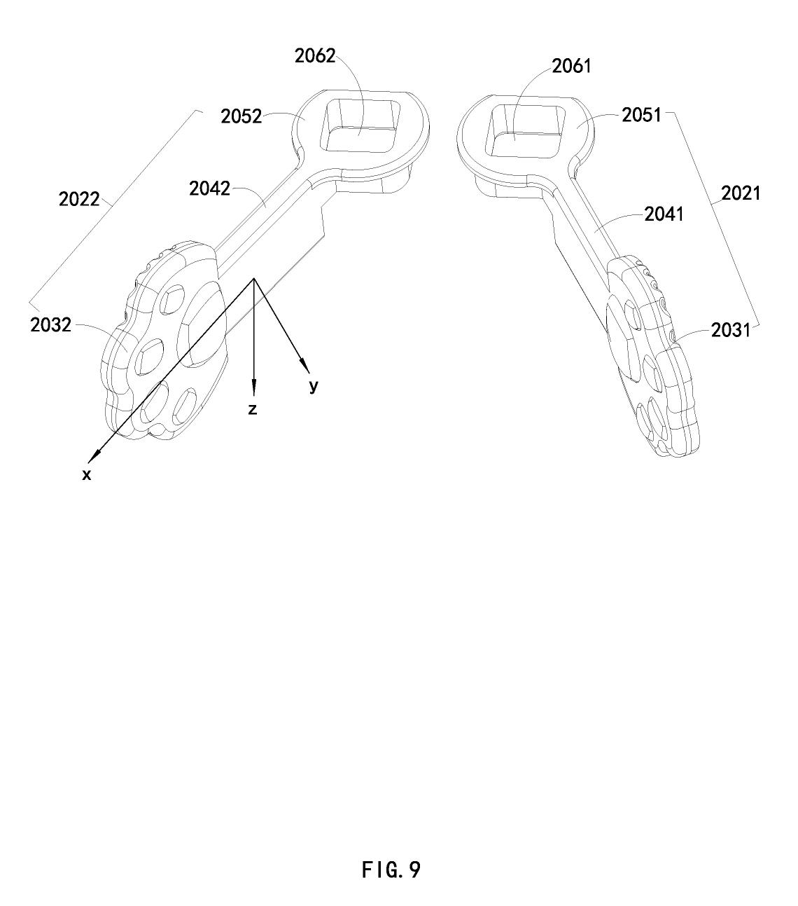

Referring to FIG. 9, one end of the first switch 2021 is provided with a first manual operating portion 2031. The first manual operating portion 2031 is connected to a first swinging portion 2041. The first swinging portion 2041 is connected to a first engaging portion 2051. A first polygonal hole 2061 is opened in the middle of the first engaging portion 2051. One end of the second switch 2022 is provided with a second manual operating portion 2032. The second manual operating portion 2032 is connected to a second swinging portion 2042. The second swinging portion 2042 is connected to a second engaging portion 2052. A second polygonal hole 2062 is opened in the middle of the second engaging portion 2052.

Among them, the above first and second manual operating portions and first and second swinging portions have height dimensions in a direction approximately perpendicular to the ground (taking the first switch 2021 as an example, this direction is the z-axis direction in FIG. 9, that is, the vertical direction when the main housing body 101 is placed on the ground) and width dimensions in a horizontal direction (the y-axis direction in FIG. 9), where the height dimension is much larger than the width dimension. The first and second engaging portions have height dimensions in a direction approximately perpendicular to the ground (the z-axis direction in FIG. 9, that is, the vertical direction when the main housing body 101 is placed on the ground) and width dimensions in a horizontal direction (the y-axis direction in FIG. 9), where the width dimension is much larger than the height dimension.

More critically, the height dimension of the first and second manual operating portions is larger than the height dimension of the first and second swinging portions, and the height dimension of the first and second swinging portions is slightly smaller than the height dimension of the rectangular window on the front side of the main housing body 101. Thus, when the user performs an opening operation or automatic closing, the first and second swinging portions of the switching member 202 can pass through the rectangular window and be restricted to slide in the horizontal direction of the rectangular window. The height dimension of the first and second manual operating portions is larger than that of the first and second swinging portions, which facilitates the first and second manual operating portions to be retained outside the rectangular window, and the relatively large size is conducive to the realization of the manual pressing action.

Furthermore, referring to FIG. 9, the overall structures of the first switch 2021 and the second switch 2022 are distributed approximately linearly along the x-axis direction (taking the first switch as an example, the description of the second switch is omitted), and the length dimension in the x direction is significantly larger than the height dimension in the z-axis direction. Combined with the maximum opening angle between the first switch 2021 and the second switch 2022 when the switching member 202 is in the default closed state, when the user presses the manual operating portion to perform an opening action, the user can obtain the maximum operating torque, constituting a labor-saving lever. That is, the user can very effortlessly achieve the opening action of the switching member 202, and the operation can be completed with one hand.

In some embodiments, the closing member 201 is rotatably connected to the main housing body 101. This facilitates control of the closing member 201 by the user through the switching member 202, and after the user releases the switching member 202, the closing member 201 can automatically close to achieve sealing of the garbage bag.

Exemplarily, the main housing body 101 is configured with two protruding columns along the first direction. One of the protruding columns extends to a connection position between the first closing door 2011 and the first switch 2021, and its lower end is fixed by a fixing cap with screws. The other protruding column extends to a connection position between the second closing door 2012 and the second switch 2022, and its lower end is fixed by a fixing cap with screws.

The inventors discovered during the design process that when taking out the garbage bag and cutting it off, existing products generally either have a heat cutting device with high cost and high failure rate, or the cutting device is arranged on the inner side of a flip door, and its position is very inconvenient for the operation of cutting off the garbage bag. The user usually needs one hand to stabilize the waste receptacle itself and the other hand to perform the cutting, so as to ensure that the waste receptacle does not tip or overturn during cutting.

In view of this, the waste receptacle provided by the solution of the present application further comprises a cutting assembly 30. The cutting assembly 30 is connected to a side of the main housing body 101 proximal to the switching member 202 for cutting the garbage bag. Exemplarily, the cutting assembly 30 is arranged on the main housing body 101 such that the cutting position faces the operator frontally. During the cutting process, the entire device is more stable in force and is not prone to tipping or overturning, and the cutting is easier in the path direction, making the use process more reasonable and humanized.

In the above implementation, the cutting assembly 30 and the switching member 202 are located on the same side of the main housing body 101, which can be used to cut off the garbage bag without excessively pulling the garbage bag, thereby preventing the waste receptacle from tipping or overturning during cutting of the garbage bag, while making operation more convenient and user-friendly.

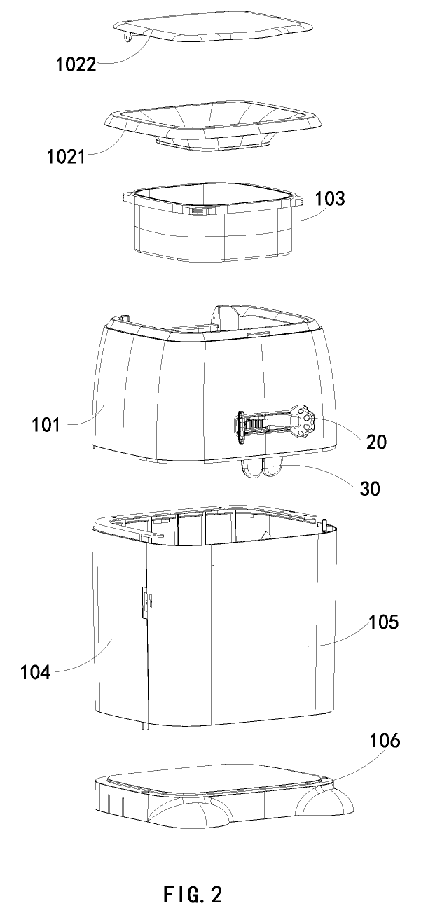

As shown in FIG. 2, the housing cover 102 includes a first cover body 1021 and a second cover body 1022. The first cover body 1021 is sleeved on the main housing body 101, and the second cover body 1022 is located at a side of the first cover body 1021 distal from the main housing body 101.

Exemplarily, the first cover body 1021 is located below the second cover body 1022. Both the first cover body 1021 and the second cover body 1022 may be rotatably connected to the main housing body 101 through a connecting shaft.

Among them, to achieve guidance when disposing of refuse, the first cover body 1021 is configured as a hollow structure. The first cover body 1021 is in communication with the waste container 103. The outer side of the first cover body 1021 is connected to the main housing body 101, and its inner side extends downward along a direction approaching the main housing body 101 to form a cone with an opening. Meanwhile, to ensure that no odor leakage will occur at the periphery between the first cover body 1021 and the main housing body 101, the upper end of the first cover body 1021 and the main housing body 101 is of a sealable covering design. For example, the first cover body 1021 may be buckled on the main housing body 101. Of course, it is not excluded to add a sealing member between the first cover body 1021 and the main housing body 101 on this basis.

It should be noted that the bottom opening dimension of the first cover body 1021 is not larger than the opening dimension of the waste container 103 to ensure smooth disposal of refuse into the garbage bag. When the first cover body 1021 covers the main housing body 101, it may be used to fix the waste container 103. When the first cover body 1021 is opened relative to the main housing body 101, it can be used to replace the waste container 103.

The second cover body 1022 may be rotatably connected to the main housing body 101. After disposing of refuse, the second cover body 1022 rotates relative to the main housing body 101, and finally the lower end surface of the second cover body 1022 abuts against the first cover body 1021, achieving a secondary sealing of the odor in the garbage bag.

In the above implementation, the first cover body 1021 is connected to the main housing body 101, and can guide refuse into the inner cavity of the waste container 103 when the user disposes of refuse, and can also serve to fix the position of the waste container. The second cover body 1022 may be rotatably connected to the main housing body 101, and can be used to cover a side of the housing assembly 10 proximal to the inlet. Connection portions of the plurality of cover body structures in the present application are all sealed, effectively reducing gas leakage during refuse disposal.

As shown in FIGS. 1-2, the housing assembly 10 further includes an accommodating housing 104. The accommodating housing 104 is connected to a side of the main housing body 101 proximal to the outlet, and the accommodating housing 104 is configured with a storage space adapted to accommodate a portion of the garbage bag passing through the closing member 201.

Exemplarily, the accommodating housing 104 is located below the main housing body 101. The accommodating housing 104 and the main housing body 101 can be detachably connected by a buckle, and the storage space of the accommodating housing 104 has a certain depth to allow the garbage bag passing through the closing assembly 20 to collect refuse in the storage space.

In some embodiments, the housing assembly 10 further includes a cover door 105. The cover door 105 is connected to the accommodating housing 104 for removing the garbage bag. It can be understood that one side of the accommodating housing 104 is configured with a take-out opening, which may be located on the same side as the switching member 202 and the cutting assembly 30 of the waste receptacle to facilitate user operation. The cover door 105 is used to cover or open the take-out opening. When the cover door 105 is opened relative to the accommodating housing 104, the user can take out the garbage bag in the storage space. When the cover door 105 covers the accommodating housing 104, the cover door 105 and the accommodating housing 104 may be in a sealed state.

Process of taking out the garbage bag: When the garbage bag is full (the user can observe by opening the cover door 105, or through a transparent observation port opened on the accommodating housing 104, or through a detection sensor for advance warning), the user opens the cover door 105. At this time, the closing assembly 20 is still in a sealed state, and no odor leakage will occur. The user holds the garbage bag tightly below the closing assembly 20 with one hand and performs a sealing operation, and then controls the switching member 202 to release with the other hand, so that the user can pull the garbage bag in a sealed state.

After pulling out a certain length, the user can directly cut the tightened garbage bag opening on the cutting assembly 30 facing the user (and located at the middle position of the waste receptacle with more balanced force) with one hand, without pulling the garbage bag to a traditional side-pull door for cutting, which is not prone to causing tipping. The cutting assembly 30 is mounted and fixed on the main housing body 101, but extends out of the lower outlet of the main housing body 101 and finally extends into the accommodating housing 104. After the user opens the cover door 105, the cutting assembly 30 can be completely observed to complete the cutting.

In some embodiments, the housing assembly 10 further includes a supporting base 106. The supporting base 106 is connected to a side of the accommodating housing 104 distal from the main housing body 101. For example, the lower part of the accommodating housing 104 is connected to the supporting base 106. The supporting base 106 is used to contact the ground for support. The accommodating housing 104 may also be integrally manufactured with the supporting base 106. It can be understood that to achieve automatic laying of the garbage bag, a vacuum pumping device is arranged on the supporting base 106. When the vacuum pumping device operates, a negative pressure can be formed around the storage space.

Description of the use process of the present product: Before use, the waste container 103 needs to be installed. For the first use, a sufficient length of the garbage bag in the waste container 103 needs to be pulled out, and then a knot is tied at the end (or called the bottom) of the garbage bag to form a garbage bag with one end open and one end closed. Open the second cover body 1022, open the first cover body 1021, and the waste container 103 can be installed. Pinch the switching member 202, and at this time the closing member 201 is opened. Place the pulled-out sufficiently long garbage bag below the closing member 201. Release the switching member 202, and the closing member 201 is closed. Close the first cover body 1021, close the second cover body 1022, and the installation is completed.

When refuse needs to be poured in, open the second cover body 1022, and refuse can be poured in. At this time, after passing through the inside of the waste container 103 (hollow structure), the refuse is located above the closing member 201, and the hollow position of the waste container 103 is located in the area between the first cover body 1021 and the closing member 201.

Pinch the switching member 202 with one hand. At this time, through the action of the first engaging portion 2013 and the second engaging portion 2014, the first closing door 2011 and the second closing door 2012 of the closing member 201 synchronously open from the center toward both sides. Meanwhile, the refuse drops into the garbage bag under gravity. Release the switching member 202, and the closing member 201 is closed. It can be understood that when specifically using the waste receptacle, the closing member 201 forms a first space position for accommodating refuse above it and between it and the housing cover, for allowing refuse to stay. The closing member 201 forms a second space position for accommodating refuse below it and between it and the accommodating housing. After the user opens the closing member 201, the second space position receives refuse falling from the first space position.

After completing the pouring of refuse, close the second cover body 1022.

If after multiple refuse loading operations, the garbage bag needs to be replaced. First, after opening the cover door 105, take out the garbage bag containing refuse from the storage space. At this time, the closing assembly 20 is still in a sealed state, and no odor leakage will occur. The cutting assembly 30 faces the operator and is located in the path direction. Press the waste receptacle with one hand to keep it fixed, and hold the garbage bag containing refuse with the other hand. Pass the garbage bag through the groove of the cutting assembly 30 to complete the cutting process. Pull the garbage bag to be used with slight force from the waste container 103 to a sufficient length, tie a knot at the head, and put it into the waste receptacle. Tie a knot and discard the garbage bag containing waste. The user's entire disposal operation process will not involve odor leakage, providing a very good user experience.

The above are merely specific embodiments of the present application. However, the protection scope of the present application is not limited thereto. Any person skilled in the art can easily conceive of changes or substitutions within the technical scope disclosed in the present application, which shall all be covered within the protection scope of the present application. Therefore, the protection scope of the present application shall be subject to the protection scope of the claims.

What is claimed is:

1. A waste receptacle, comprising:
a housing assembly comprising a main housing body, an accommodating housing, and a housing cover, wherein both the main housing body and the accommodating housing are configured with hollow channels, a garbage bag being disposed within said channels, the main housing body being connected to the housing cover at an upper side thereof and to the accommodating housing at a lower side thereof;
the waste receptacle further comprising a closing assembly, wherein when the closing assembly is in an open state, refuse is allowed to pass through a gathered opening of the garbage bag and drop into the garbage bag, and when the closing assembly is in a closed state, the closing assembly is adapted to clamp the gathered opening of the garbage bag.

2. The waste receptacle according to claim 1, wherein the waste receptacle further comprises a cutting assembly disposed on the main housing body at a side proximal to a user.

3. The waste receptacle according to claim 2, wherein the closing assembly comprises a closing member and a switching member, the switching member being connected to the closing member and controlling opening and closing of the closing member.

4. The waste receptacle according to claim 3, wherein the closing member has a first closing door and a second closing door, abutting portions of the first closing door and the second closing door are respectively provided with mutually cooperating sealing structures.

5. The waste receptacle according to claim 4, wherein the abutting portion of the first closing door is provided with an L-shaped first downward extending edge, and the abutting portion of the second closing door is provided with a U-shaped second downward extending edge;
in a closed state of the switching member, the L-shaped first downward extending edge of the first closing door is embedded into the U-shaped second downward extending edge of the second closing door.

6. The waste receptacle according to claim 3, wherein the switching member has a first switch and a second switch, the first switch and the second switch being connected to the first closing door and the second closing door respectively; both the first switch and the second switch have a manual operating portion, a swinging portion connected to the manual operating portion, and a engaging portion connected to the swinging portion; the engaging portion is provided with a polygonal through hole adapted to polygonal protrusion structures on corresponding closing doors to complete connection between corresponding switches and closing doors.

7. The waste receptacle according to claim 6, wherein the manual operating portion, the swinging portion, and the engaging portion of the first switch and the second switch each have dimensions in length, height, and width directions, wherein height dimensions of both the manual operating portion and the swinging portion are larger than a height dimension of the engaging portion, and a height dimension of the manual operating portion is larger than a height dimension of the swinging portion; length dimensions of the first switch and the second switch are larger than height dimensions thereof, the first switch and the second switch constituting labor-saving levers during opening operations.

8. The waste receptacle according to claim 5, wherein the closing assembly forms a first space position for accommodating refuse above the closing assembly and a second space position for accommodating refuse below the closing assembly, the closing member being located within the channel of the housing assembly; the swinging portion of the switching member passes through a rectangular window on the housing assembly to connect with the manual operating portion located outside the housing assembly.

9. The waste receptacle according to claim 7, wherein the closing assembly forms a first space position for accommodating refuse above the closing assembly and a second space position for accommodating refuse below the closing assembly, the closing member being located within the channel of the housing assembly; the swinging portion of the switching member passes through a rectangular window on the housing assembly to connect with the manual operating portion located outside the housing assembly.

10. The waste receptacle according to claim 8, wherein the housing cover comprises a first cover body and a second cover body, the first cover body being sleeved on the main housing body and being of a hollow structure extending from periphery toward a center in an arcuate or conical manner; the second cover body is located at a side of the first cover body distal from the main housing body; the accommodating housing is located below the main housing body and is configured with a storage space adapted to accommodate a portion of the garbage bag passing through the closing member; the accommodating housing is provided with a cover door; the housing assembly further comprises a supporting base connected to a side of the accommodating housing distal from the main housing body.

11. The waste receptacle according to claim 9, wherein the housing cover comprises a first cover body and a second cover body, the first cover body being sleeved on the main housing body and being of a hollow structure extending from periphery toward a center in an arcuate or conical manner; the second cover body is located at a side of the first cover body distal from the main housing body; the accommodating housing is located below the main housing body and is configured with a storage space adapted to accommodate a portion of the garbage bag passing through the closing member; the accommodating housing is provided with a cover door; the housing assembly further comprises a supporting base connected to a side of the accommodating housing distal from the main housing body.

12. A method of using the waste receptacle, the waste receptacle comprising:
a housing assembly comprising a main housing body, an accommodating housing, and a housing cover, wherein both the main housing body and the accommodating housing are configured with hollow channels, a garbage bag being disposed within said channels, the main housing body being connected to the housing cover at an upper side thereof and to the accommodating housing at a lower side thereof;
the waste receptacle further comprising a closing assembly, wherein when the closing assembly is in an open state, refuse is allowed to pass through a gathered opening of the garbage bag and drop into the garbage bag, and when the closing assembly is in a closed state, the closing assembly is adapted to clamp the gathered opening of the garbage bag;
wherein the method comprises:
step 1: the user pulls out an appropriate length of garbage bag from a waste container and stores it in the accommodating housing; making a knot at a bottom of the garbage bag if necessary, the waste receptacle being in a ready-to-use state wherein the closing member is in a tightened closed state;
step 2: after collecting refuse, the user opens the second cover body of the waste receptacle and disposes the refuse, the refuse staying above the closing member based on the closed state of the closing member;
step 3: after disposing the refuse, the user closes the second cover body to complete the refuse disposal action within an extremely short time;
step 4: the user presses the switching member to control the closing member to be in an open state, allowing the refuse staying above the closing member to drop to a bottom of the garbage bag in the accommodating housing based on its own gravity;
step 5: the user releases the switching member, the closing member automatically returning to a closed state such that the gathered opening of the garbage bag is again in a sealed state, the waste receptacle returning again to the ready-to-use state until the garbage bag is full, then cutting by the cutter, and returning again to step 1 for cyclic use.

13. The method according to claim 12, wherein the waste receptacle further comprises a cutting assembly disposed on the main housing body at a side proximal to a user.

14. The method according to claim 13, wherein the closing assembly comprises a closing member and a switching member, the switching member being connected to the closing member and controlling opening and closing of the closing member.

15. The method according to claim 14, wherein the closing member has a first closing door and a second closing door, wherein abutting portions of the first closing door and the second closing door are provided with mutually cooperating sealing structures.

16. The method according to claim 15, wherein the abutting portion of the first closing door is provided with an L-shaped first downward extending edge, and the abutting portion of the second closing door is provided with a U-shaped second downward extending edge;
in a closed state of the switching member, the L-shaped first downward extending edge of the first closing door is embedded into the U-shaped second downward extending edge of the second closing door.

17. The method according to claim 14, wherein the switching member has a first switch and a second switch, the first switch and the second switch being connected to the first closing door and the second closing door respectively; both the first switch and the second switch have a manual operating portion, a swinging portion connected to the manual operating portion, and a engaging portion connected to the swinging portion; the engaging portion is provided with a polygonal through hole adapted to polygonal protrusion structures on corresponding closing doors to complete connection between corresponding switches and closing doors.

18. The method according to claim 17, wherein the manual operating portion, the swinging portion, and the engaging portion of the first switch and the second switch each have dimensions in length, height, and width directions, wherein height dimensions of both the manual operating portion and the swinging portion are larger than a height dimension of the engaging portion, and a height dimension of the manual operating portion is larger than a height dimension of the swinging portion; length dimensions of the first switch and the second switch are larger than height dimensions thereof, the first switch and the second switch constituting labor-saving levers during opening operations.

19. The method according to claim 16, wherein the closing assembly forms a first space position for accommodating refuse above the closing assembly and a second space position for accommodating refuse below the closing assembly, the closing member being located within the channel of the housing assembly; the swinging portion of the switching member passes through a rectangular window on the housing assembly to connect with the manual operating portion located outside the housing assembly.

20. The method according to claim 18, wherein the closing assembly forms a first space position for accommodating refuse above the closing assembly and a second space position for accommodating refuse below the closing assembly, the closing member being located within the channel of the housing assembly; the swinging portion of the switching member passes through a rectangular window on the housing assembly to connect with the manual operating portion located outside the housing assembly.
